(19) United States
(12) Patent Application Publication
(10) Pub. No.: US 2009/0012833 A1
(43) Pub. Date: Jan. 8, 2009

(54) SEARCH ENGINE FOR MOST HELPFUL EMPLOYEES

(75) Inventors: Matthew Kuhlke, San Francisco, CA (US); Gebran G. Chahrouri, Menlo Park, CA (US); John A. Toebes, Cary, NC (US)

Correspondence Address: CISCO SYSTEMS, INC.;SCIENTIFIC-ATLANTA, INC., SA/CISCO IP DEPT., 5030 SUGARLOAF PARKWAY, LAWRENCEVILLE, GA, 30044, US

(73) Assignee: CISCO TECHNOLOGY, INC., San Jose, CA (US)

(21) Appl. No.: 11/772,318

(22) Filed: Jul. 2, 2007

(51) Int. Cl. G06F 9/46; G06F 17/30; G06Q 10/00

(52) U.S. Cl. 705/9; 705/11; 705/1; 707/104.1

(57) ABSTRACT

Methods and apparatus for identifying experts in a subject area are disclosed. According to one aspect of the present invention, a method includes receiving a request to locate a source of expertise in a subject area within an enterprise, and determining if there is at least one individual associated with the enterprise that has the expertise in the subject area. The method also includes identifying the individual if it is determined that there is the at least one individual who has the expertise in the subject area by comparing a profile associated with an initiator of the request with a profile associated with the individual. Information associated with the individual is provided such that the individual may be identified as the source of expertise in the subject area.

### BACKGROUND OF THE INVENTION

The present invention relates generally to systems which enable members of an enterprise to be rated or otherwise assessed, and classified based on their expertise, willingness, and ability to provide assistance in their areas of expertise.

In large enterprises, it is often difficult to identify a member of the enterprise who may be an expert in a particular subject area. By way of example, one member of a corporation may have a question regarding a particular subject area, and may wish to speak with a colleague who has expertise in the subject area. However, identifying a colleague with expertise may be an arduous, inefficient process, as it may be necessary to contact many members of the enterprise in an effort to determine the identity of the colleague with the most expertise. Further, an extensive inquiry process within the enterprise may fail to identify a suitable expert, even if there is one, if the inquiry process does not happen to uncover the one member of the enterprise or corporation who may know who the expert in a particular subject area is.

### BRIEF DESCRIPTION OF THE DRAWINGS

The invention may best be understood by reference to the following description taken in conjunction with the accompanying drawings in which:

FIG. 1 is a block diagram representation of factors which may be utilized by a computing system to determine an expert rating for an individual in accordance with an embodiment of the present invention.

FIG. 2 is a process flow diagram which illustrates a method of a user identifying and contacting an expert associated with a particular subject area in accordance with an embodiment of the present invention.

FIG. 3A is a process flow diagram which illustrates one method of contacting an expert that is identified by an expertise system, e.g., step 225 of FIG. 2, in accordance with an embodiment of the present invention.

FIG. 3B is a process flow diagram which illustrates another method of contacting an expert that is identified by an expertise system, e.g., step 225 of FIG. 2, in accordance with an embodiment of the present invention.

FIG. 4 is a process flow diagram which illustrates a process which allows a user to provide information that contributes to an expert rating for an individual in accordance with an embodiment of the present invention.

FIG. 5 is a process flow diagram which illustrates a method of obtaining information associated with the expertise available within an overall environment in accordance with an embodiment of the present invention.

FIG. 6 is a process flow diagram which illustrates a method of identifying experts in response to a request from a user and providing the user with a list of the identified experts in accordance with an embodiment of the present invention.

FIG. 7 is a diagrammatic representation of an expertise system which identifies a list of experts in a particular subject area in response to a request for an expert in the particular subject area in accordance with an embodiment of the present invention.

### DESCRIPTION OF THE EXAMPLE EMBODIMENTS

### General Overview

In one embodiment, a method includes receiving a request to locate a source of expertise in a subject area within an enterprise, and determining if there is at least one individual associated with the enterprise that has the expertise in the subject area. The method also includes identifying the individual if it is determined that there is the at least one individual who has the expertise in the subject area by comparing a profile associated with an initiator of the request with a profile associated with the individual. Information associated with the individual is provided such that the individual may be identified as the source of expertise in the subject area.

### Description

A system which obtains and maintains information relating to the expertise attribute members of an enterprise allows an appropriate expert to be efficiently identified. In one embodiment, a searchable database that contains information relating to the expertise of members of an enterprise may be searched when there is a request for an expert. When experts are effectively identified, and information relating to the experts is stored in a searchable database, an appropriate expert for a given subject area may be relatively rapidly identified. In addition, once a user contacts an appropriate expert for a particular subject area, the familiarity with the subject matter on the part of the expert allows for relatively quick collaboration.

An expertise system, e.g., a system that includes an engine arranged to identify experts and a searchable database that is accessed by the engine, may generally be arranged to create profiles for experts, obtain input that may be used to create the profiles, and identify suitable experts in response to requests for experts. Such an expertise system may be accessible within an enterprise such that members of an enterprise may interact with the expertise system over a network.

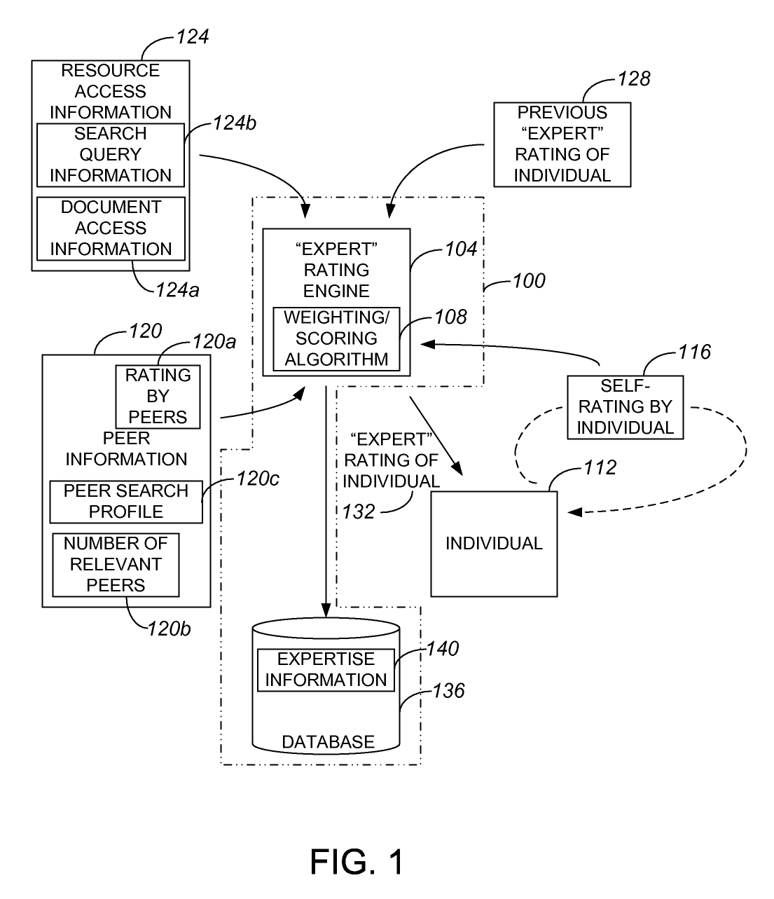

For an individual or member of an enterprise who has experience in a particular subject area, an “expert” rating may be calculated or otherwise determined. A variety of different factors may be used to determine an expert rating for an individual. With reference to FIG. 1, factors which may be used by an expertise system to determine an expert rating for an individual will be described in accordance with an embodiment of the present invention. An expertise system 100 includes an “expert” rating engine 104 and a database 136. Expert rating engine 104 includes a weighting/scoring algorithm 108 that is arranged to determine an expert rating 132 for an individual 112. In general, weighting/scoring algorithm 108 may be implemented as logic embodied in a tangible media. By way of example, weighting/scoring algorithm 108 may include software logic that is executed by expert rating engine 104 and/or hardware logic.

When executed, expert rating engine 104 may obtain information associated with individual 112, and provide that information to weighting/scoring algorithm 108 for processing. Weighting/scoring algorithm 108 may process the obtained information to generate expert rating 132, which may then be stored in database 136 or, more specifically, in a data structure 140 of database 136 that stores expertise information. Data structure 140 may store information relating to the expertise of individual 112, as well as tags which identify subject areas in which individual 112 may be considered to be an expert. It should be appreciated that weighting/scoring algorithm 108 may generally provide different weights to different types of information, and that the different weights may vary depending upon the requirements of a particular enterprise.

Individual 112 may provide a self-rating 116 to expert rating engine 104. Self-rating 116 may include an assessment by individual 112 of his/her willingness to provide assistance to peers, and his/her own perception of his/her expertise in a particular subject area. In one embodiment, self-rating 116 may effectively be solicited by a survey (not shown) that is initiated and administered by expert rating engine 104. Alternatively, self-rating 116 may be substantially voluntarily provided by individual 112 when individual 112 accesses a website (not shown) associated with expert rating engine 104.

Typically, peer information 120, or information provided by peers of individual 112, is used by weighting/scoring algorithm 108 to generate expert rating 132. Peer information 120 may include substantially any suitable information associated with the peers. Such information may include, but is not limited to including, ratings 120a provided by peers, a number 120b of relevant peers, and search profiles 120c associated with the peers. While peer information 120 may be store at any suitable location, peer information 120 may be stored in a database such as database 136.

Ratings 120a, which may be obtained via a survey (not shown) administered by expert rating engine 104 after the peers have received assistance from individual 112, are generally assessments of individual 112 provided by the peers. For example, ratings 120a may include information relating to the overall helpfulness of individual 112, the willingness of individual 112 to provide assistance, and the expertise level of individual 112 relative to a particular subject area. In one embodiment, ratings 120a may be used by weighting/scoring algorithm 108 as a part of an “aid score” that factors into expert rating 132. Number 120b of relevant peers generally relates to the number of peers who have actually contacted, or attempted to contact, individual 112 to obtain assistance in a particular subject area. Peer search profiles 120c may include information relating to search queries initiated by and documents accessed by the peers who have actually contacted, or attempted to contact, individual 112.

Resource access information 124 associated with individual 112 may also be obtained by expert rating engine 104, e.g., from an application that monitors web usage or an application that tracks internet access history, for use in generating expert rating 132. Resource access information 124 may include document access information 124a and search query information 124b, and may be stored in data structure 140. Document access information 124a may identify documents accessed by individual 112 in a particular subject area, while search query information 124b may identify subjects of search queries initiated by individual 112. An enterprise may track substantially all member search queries and document access, both internal with respect to the enterprise and external. If individual 112 is determined to be searching for and reading documents related to a specific subject area, weighting/scoring algorithm 108 may interpret such behavior by individual 112 as gaining expertise in that subject area. Hence, the degree of knowledge attributed to individual 112 with respect to the specific subject area may be considered to be relatively high, particularly if individual 112 is an author or contributor to any of the documents identified in document access information 124a. In one embodiment, once the effective access to that subject area by individual 112 reaches a predetermined threshold, e.g., based upon a depth and length of investigation and degree of interaction with documents, weighting/scoring algorithm 108 may reach the conclusion that individual 112 is an expert in that subject area.

Expert rating engine 104 may also utilize a previous expert rating 128, if available, for individual 112, and factor previous expert rating 128 into a determination of a new, or updated, expert rating 132. In general, previous expert rating 128 may be stored as expertise information in data structure 140 of database 136, although it should be appreciated that previous expert rating 128 is not limited to being stored in data structure 140.

In one embodiment, expert rating engine 104 may compare information 124a, 124b to information stored in peer search profile 120c to determine expert rating 132 such that expert rating 104 is substantially unique to a given peer. For example, if individual 112 has a similar search query history and document access history to that of a peer, in terms of that peer, individual 112 may have a particularly high expert rating 104.

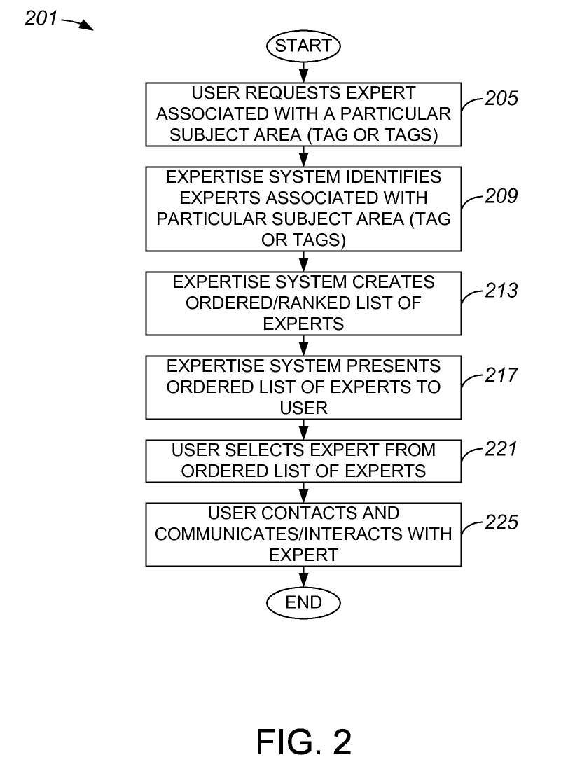

Expertise system 100 may be accessed by a user to identify an expert, e.g., an individual with a relatively high expert rating, for a particular subject area. Referring next to FIG. 2, one method which allows a user to identify an expert for a particular subject area will be described in accordance with an embodiment of the present invention. A process 201 of identifying an expert for a particular subject area begins at step 205 in which a user requests an expert associated with a particular subject area using the expertise system. A request may identify a particular subject area, in which case the expertise system may parse the string containing the subject area to identify a tag or tags. Alternatively, a user may provide tags in his/her request.

After the user makes a request for an expert, the expertise system identifies experts associated with the particular subject area in step 209. For ease of discussion, it is assumed that there is at least one individual with expertise in the particular subject area, although it should be appreciated that there may not necessarily be a suitable expert in the particular subject area. The identification of experts may include searching a database within the expertise system.

Once the experts associated with the particular subject area are identified, the expertise system creased an ordered or ranked list of the experts in step 213. The order in which the experts are listed may be based on an overall expert rating score. In one embodiment, the personal preferences of the user may be accounted for in ordering the list. By way of example, if the user has previously contacted a particular expert, or if a particular expert is located in the same building as the user, such experts may be prioritized over others in the list, even if those experts may actually have a lower expert rating score than others.

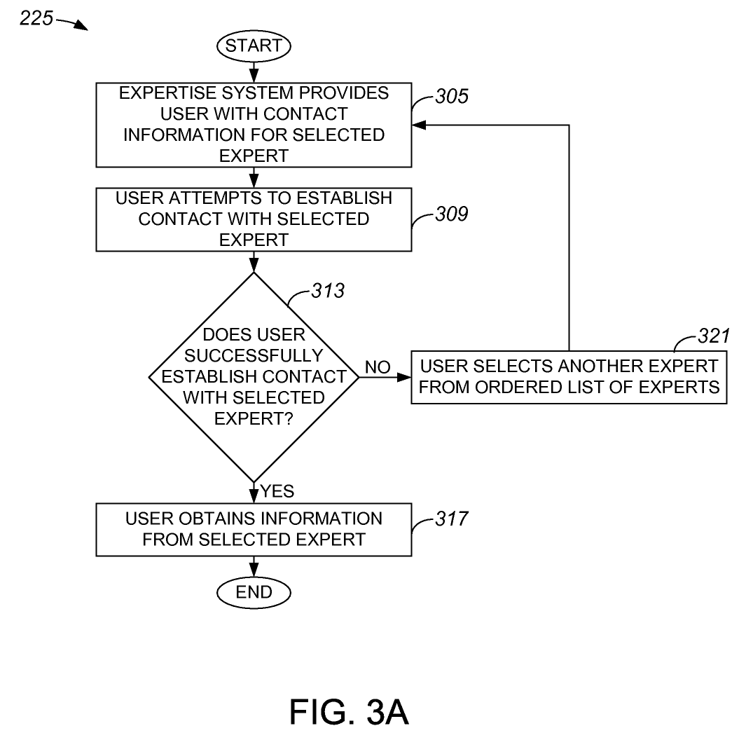

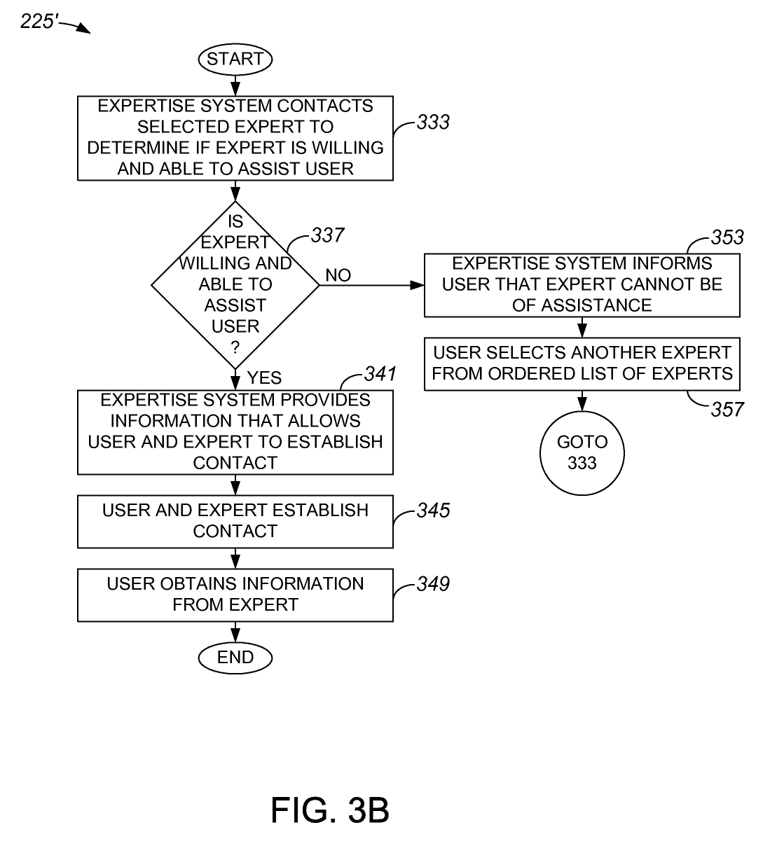

In step 217, the expertise system presents the ordered list of experts to a user. The expertise system may present the ordered list on a web page that is viewed by the user. The ordered list may include contact information for the experts, or may include substantially only the name of the expert. Using the list of experts, the user may select an expert to contact in step 221. Finally, in step 225, the user contacts and communicates with the selected expert in step 225. Methods which may be used by a user to contact an expert will be discussed below with respect to FIGS. 3A and 3B. After the user contacts an expert, the process of identifying an expert for a particular subject area is completed.

A user may contact and communicate with a selected expert substantially independently from an expertise system. That is, a user may identify an expert using an expertise system, but then establish contact with the expert using a method that is not associated with the expertise system, e.g., the user may telephone the expert or sent e-mail to the expert using an application that is not integrated into the expertise system. A user may generally either assess the availability of an expert by contacting the expert, as will be described with respect to FIG. 3A, or receive information relating to the availability of the expert from the expertise system, as will be described with respect to FIG. 3B.

FIG. 3A is a process flow diagram which illustrates one method of contacting an expert that is identified by an expertise system, e.g., step 225 of FIG. 2, that involves a user assessing the availability of the expert in accordance with an embodiment of the present invention. A process 225 of contacting an expert begins at step 305 in which the expertise system provides the user with contact information for the expert selected by the user. Such information may be provided on a web page, via an e-mail, or by substantially any suitable method. After the user is provided with contact information for the selected expert, the user attempts to establish contact with the selected expert in step 309. In one embodiment, the user may send an e-mail, send an instant message or chat invitation, or initiate a telephone call.

A determination is made in step 313 as to whether the user has successfully established contact with the selected expert. That is, it is determined whether the selected expert has agreed to help or assist the user. If it is determined that the user has not successfully established contact with the selected expert, the user selects another expert in step 321, as for example using the ordered list generated from a request for an expert. It should be appreciated that the user may instead select another expert after initiating a new search for an expert. Once the user selects another expert, if there is another expert available, process flow returns to step 305 in which the expertise system provides the user with contact information for the selected expert.

Returning to step 313, if the determination is that the user has successfully established contact with the selected expert, the user obtains information from the selected expert in step 309. In other words, the user and the selected expert interact such that the selected expert may provide assistance to the user. The process of contacting an expert is completed once the user obtains information from the selected expert.

FIG. 3B is a process flow diagram which illustrates a method of contacting an expert that is identified by an expertise system, e.g., step 225 of FIG. 2, that involves the expertise system assessing the availability of the expert in accordance with an embodiment of the present invention. A process 225′ of contacting an expert begins at step 333 in which an expertise system contacts a selected expert, i.e., an expert selected by a user, to determine if the selected expert is willing and able to assist the user. The expertise system may generally ping the expert to solicit a response once the user has selected the expert. In step 337, it is determined if the expert is willing and able to assist the user. If the expert indicates an unwillingness and/or an inability to assist the user, the expertise system informs the user in step 353 that the selected expert is unavailable to render assistance. Then, in step 357, the user selects another expert from an ordered list of experts, e.g., the list generated in step 221 of FIG. 2. Once the user selects another expert, process flow returns to step 333 in which the expertise system contacts the selected expert to assess the willingness and ability of the expert to render assistance to the user.

Returning to step 337, if it is determined that the expert willing and/or able to assist the user, the expertise system provides information in step 341 that allows the user and the selected expert to establish contact. The expertise system may provide the selected expert with contact information for the user to enable the selected expert to contact the user. Alternatively, the expertise system may provide the user with contact information for the selected expert to allow the user to contact the selected expert. In step 345, the user and the expert establish contact, and in step 348, the user obtains information from the expert. After the user obtains information from the expert, the process of contacting an expert is completed.

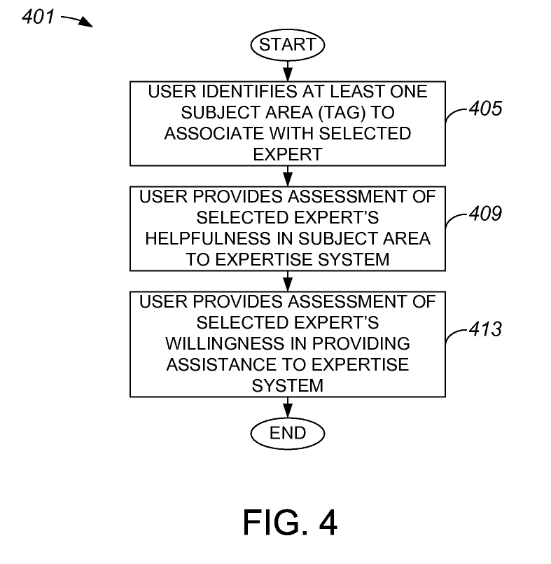

In general, to assign an expert rating, or a rating score, to an individual, a user who has interacted with the individual is asked for feedback regarding his/her experience with the individual. Such feedback may be provided using a survey administered by the expertise system With reference to FIG. 4, a process which allows a user to provide information that contributes to an rating score for an individual will be described in accordance with an embodiment of the present invention. A process 401 of providing user feedback associated with an individual to an expertise system begins at step 405 in which the user identifies at least one subject area or tag to associate with the selected expert. The user may enter a character string that identifies a subject area or a tag that the user believes is relevant to the expert. The character string may be entered using a user interface associated with the expertise system. Alternatively, the expertise system may present the user with a list of potential subject areas or tags from which the user may select at least one subject area or tag to associate with the selected expert.

Once the user identifies at least one subject area or tag, the user provides an assessment of the helpfulness of the selected expert in step 409. The assessment is typically based on the helpfulness relative to the subject area identified in step 405. The assessment may be provided as a character string, or may be provided by making selected on a user interface screen, e.g., by selecting a radio button for a desired assessment. In step 413, the user provides an assessment of the willingness of the selected expert in providing assistance using any suitable method. After the assessments are provided to the expertise system, the process of providing user feedback is completed.

At substantially any point in time, independent of whether a user has recently interacted with an individual who may be an expert in a particular subject area, a user may provide an assessment of the individual that may be used to determine an expert rating, or rating score, for the individual. An expertise system may also solicit input from employees regarding other employees if the expertise system is generating new subject areas or tags that are to be incorporated, or if the expertise system wishes to assess the expertise available within an overall enterprise or environment.

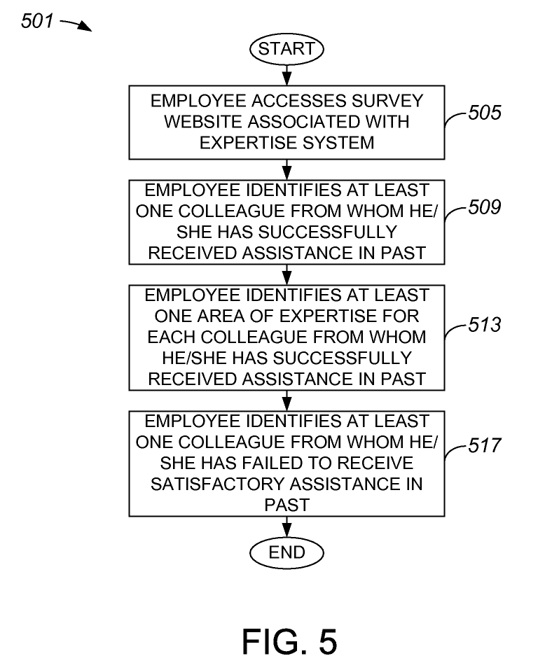

FIG. 5 is a process flow diagram which illustrates a method of obtaining information associated with the expertise available within an overall environment in accordance with an embodiment of the present invention. A process 501 of obtaining expertise information begins at step 501 in which an employee of an enterprise accesses a survey associated with an expertise system within the enterprise. The employee may access the survey substantially at-will, or when directed to do so by the enterprise system. In step 509, the employee identifies at least one colleague from whom he/she has successfully received assistance in the past. Then, in step 513, the employee identifies at least one area of expertise for each colleague from whom he/she has successfully received assistance in the past. In one embodiment, input associated with the areas of expertise may effectively be restricted to a pre-defined list complied by the enterprise.

After areas of expertise for colleagues are identified, the employee identifies at least one colleague in step 517 from whom he/she has failed to receive satisfactory assistance in the past. In general, aid scores that are factored into overall rating scores are based upon how many times an individual has been identified as giving positive, or satisfactory assistance, and how many times an individual has been identified as giving negative, or unsatisfactory assistance. Weighting of factors affecting an overall expert rating may be such that the overall expert rating for an individual decreases significantly as the number of negative references provided for the individual increases. Once the employee identifies at least one colleague from whom he/she has failed to receive satisfactory assistance in the past, the process of obtaining expertise information is completed.

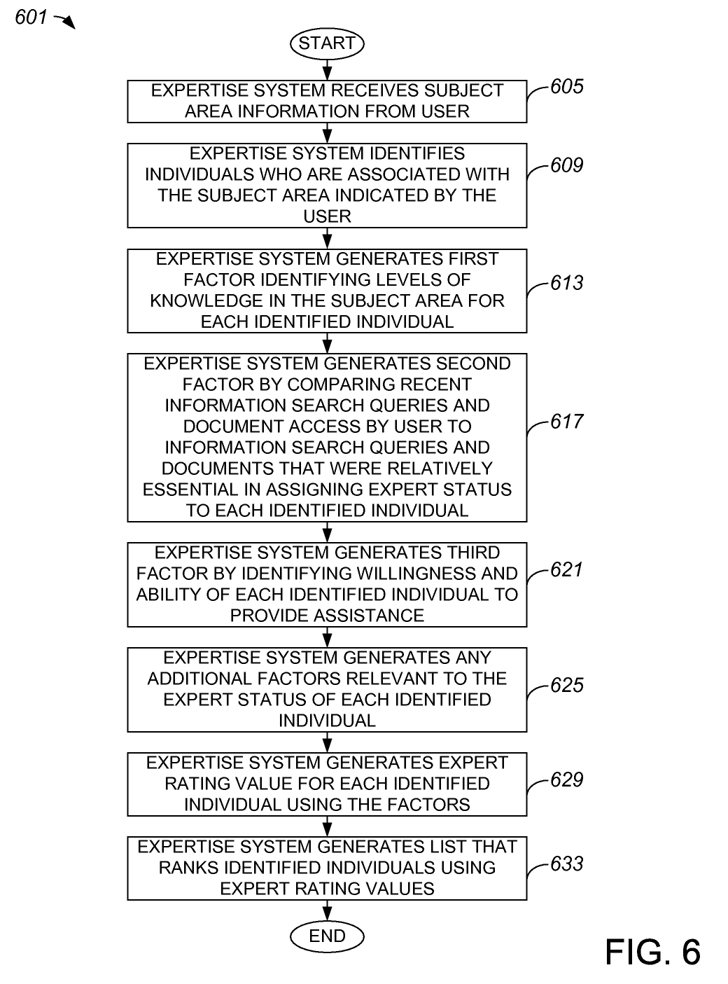

When an expertise system receives a request for assistance regarding a particular subject are from a user, the expertise system generates a list of experts that the user may select from, as previously mentioned. In one embodiment, the expertise system may generate updated rating scores for individuals in response to a request for assistance, although it should be appreciated that the expertise system may periodically update rating scores such that relatively current rating scores are generally available when there is a request for assistance. FIG. 6 is a process flow diagram which illustrates a method of identifying experts in response to a request from a user and providing the user with a list of the identified experts in accordance with an embodiment of the present invention. A process 601 of providing a user with a list of experts begins at step 605 in which an expertise system receives subject area information from a user, e.g., as a part of a search for an expert in a particular subject area. In step 608. the expertise system identifies individuals who are associated with the subject area indicated by the user. It should be appreciated that a user may indicate more than one subject area, in which case the expertise system may identify individuals who are associated with both subject areas, as well as individuals who are associated with only one of the subject areas.

After the expertise system identifies individuals who are associated with the subject area indicated by the user, the expertise system generates a first factor in step 613 for use by a weighting/scoring algorithm. The first factor may identify levels of knowledge in the subject area for each of the identified individuals, i.e., a first factor that indicates a level of knowledge is generated for each identified individual. The first factor is effectively arranged to identify individuals who have the highest degree of knowledge in the subject area.

A second factor is generated by the expertise system in step 617 for each identified individual. The second factor, which is arranged to be used by a weighting/scoring algorithm, is generated by a comparison of recent information search queries and document access by the user to information search queries and documents that were relatively essential in assigning an expert status to each identified individual. By comparing search queries and document access information, a user may be transparently matched up to an individual who has worked on, e.g., provided information relating to, the subject area in the past. Two parties who are known to have executed the same search queries and interacted with the same documents are likely to have worked on similar tasks.

Once the second factor for each identified individual is ascertained, the expertise system generates a third factor, or aid score, for each identified individual in step 621. The third factor identifies the willingness and ability of each identified individual to provide assistance. In one embodiment, the third factor may consider a self-rating for each identified individual. In step 625, the expertise system generates any additional factors that may be relevant to the expert status or rating score of each identified individual. By way of example, additional factors may include the age and recency associated with the expert status of each individual such that older rating information is weighed less than recent rating information.

The expertise system generates an expert rating value or score for each identified individual using the factors in step 629. Upon generating expert rating values, the expertise system generates a list that ranks the identified individuals using their expert rating values in step 633. Once the list is generated, the process of providing a user with a list of experts is completed.

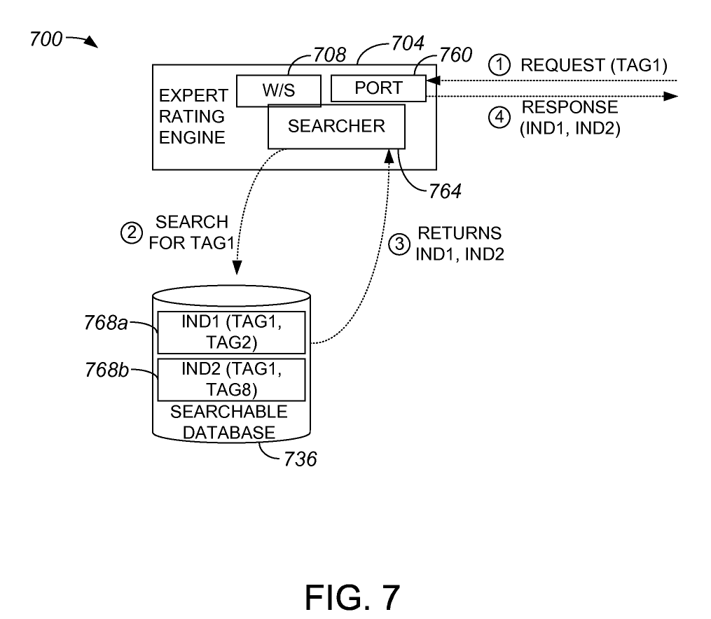

FIG. 7 is a diagrammatic representation of an expertise system which identifies a list of experts in a particular subject area in response to a request for an expert in the particular subject area in accordance with an embodiment of the present invention. An expertise system 700 includes an expert rating engine 704 and a searchable database 736 in which information 768a, 768b relating to individuals is stored. Information 768a, 768b may be stored in searchable database 736 such that information 768a, 768 may be searched by tags and/or subject areas.

A port 760 of expert rating engine 704 is arranged to receive a request, as for example from a user, that specifies a tag. Using the tag, a searcher 764 within expert rating engine 704 accesses searchable database 736 to locate information 768a, 768b that identifies individuals who are experts in a subject associated with the tag. Searcher 764, obtains the identities of individuals associated with the tag, and provides information to a weighting/scoring algorithm 708 such that the identified individuals may each be assigned an expert rating or rating value. It should be appreciated that searcher 764 may generally be arranged to obtain substantially all information which is needed by weighting/scoring algorithm 708 to generate rating values. In one embodiment, searcher 764 may be incorporated into weighting/scoring algorithm 708. Once weighting/scoring algorithm 764 generates rating values for identified individuals, a ranked list of the identified individuals is sent by port 760 in a response, e.g., to a user.

Although only a few embodiments of the present invention have been described, it should be understood that the present invention may be embodied in many other specific forms without departing from the spirit or the scope of the present invention. In one embodiment, more than one list of experts may be generated for a particular subject area. If a particular subject area is associated with more than one tag, a list of experts associated with each tag may be created. For instance, if a particular subject area is “search engine for helpful employees,” tags associated with the particular subject area may include, but are not limited to including, a “search engine” tag, a “helpful employees” tag, and a “search engine for helpful employees” tag. If there are a plurality of tags associated with a particular subject area, in addition to ranking experts associated with each tag, the tags may also be ranked by potential relevance, e.g., the “search engine for helpful employees” may be identified as being more relevant that the “search engine” tag and the “helpful employees” tag.

While an expertise system may facilitate contact between a user requesting assistance and a selected expert by ascertaining whether the selected expert is willing to assist the user and the notifying the user to contact the expert, the expertise system itself may be used to allow communications between the user and the selected expert. For example, the user may be allowed to select an expert from a list of potential experts such that an instant messenger or chat connection is initiated between the user and the selected expert. Such a connection may enable the user to efficiently establish communications with the selected expert, and obtain assistance substantially immediately. Alternatively, the user may be allowed to select an expert from a list of potential experts such that the telephone number of the selected expert is substantially automatically dialed, or such that an e-mail to the selected expert which indicates that the user would appreciate assistance is substantially automatically generated and sent. In other words, the expertise system itself may initiate or otherwise establish communications between a user and a selected expert.

It should be appreciated that the information used to ascertain an expert rating from an individual may vary widely, By way of example, while information such as a self-rating by an individual, peer information, resource access information, and previous expert ratings for the individual may be used to ascertain an expert rating, other information may also be used. In one embodiment, information relating to publications of the individual in a particular subject area may be used to determine an expert rating for the individual, Additionally, not all of the information described above with respect to FIG. 1 is necessarily used to determine an expert rating. For instance, a self-rating by an individual may be eliminated from the determination of an expert rating.

In general, the expert rating of an individual may be a function of time. For example, an individual who has not helped a peer for a significant length of time may be given a lower expert rating than an individual who has recently helped a peer. That is, in weighting the importance of factors used to generate expert ratings, the recency with which an individual has aided a peer may be weighted such that an individual who has provided assistance more recently than another individual is given a higher recency rating. Further, an individual may also “age out” as an expert if the expert has not provided any assistance in a subject area, or accessed any information relating to the subject area, for a predetermined length of time without departing from the spirit or the scope of the present invention.

The steps associated with the methods of the present invention may vary widely. Steps may be added, removed, altered, combined, and reordered without departing from the spirit of the scope of the present invention. Therefore, the present examples are to be considered as illustrative and not restrictive, and the invention is not to be limited to the details given herein, but may be modified within the scope of the appended claims.

What is claimed is:

1. A method comprising:
receiving a request to locate a source of expertise in a subject area from an initiator of the request, the source of expertise being associated with an enterprise;
determining if there is at least one individual who has the expertise in the subject area, the at least one individual being associated with the enterprise;
identifying the at least one individual who has the expertise in the subject area if it is determined that there is the at least one individual who has the expertise in the subject area, wherein identifying the at least one individual includes comparing a first profile associated with an initiator of the request with a second profile associated with the at least one individual who has the expertise in the subject area; and
providing information associated with the at least one individual who has the expertise in the subject area to the initiator, wherein providing the information associated with the at least one individual who has the expertise in the subject area allows the at least one individual to be identified as the source of expertise in the subject area.

2. The method of claim 1 wherein the first profile includes profile information associated with search queries of the initiator of the request and profile information associated with document access of the initiator of the request, and wherein the second profile includes profile information associated with search queries of the at least one individual of the request and profile information associated with document access of the at least one individual.

3. The method of claim 1 wherein if the at least one individual who has the expertise in the subject area includes a first individual and a second individual, providing the information associated with the first individual and the second individual includes:
determining if the first individual has a higher expertise ranking than the second individual, the first individual having a first expertise rating and the second individual having a second expertise rating; and
ranking the first individual ahead of the second individual in a list if the first expertise rating is higher than the second expertise rating.

4. The method of claim 3 further including:
determining the first expertise rating, wherein determining the first expertise rating includes executing a weighting/scoring algorithm that accounts for at least one selected from the group including a self-rating by the first individual, at least one peer rating that assesses a expertise of the first individual, at least one peer rating that assesses a willingness of the first individual in providing assistance, at least one peer rating that assesses a helpfulness of the first individual, historical search query information associated with the first individual, and historical document access information associated with the first individual.

5. The method of claim 3 further including:
receiving an assessment of the first individual; and
updating the first expertise rating based on the assessment.

6. The method of claim 5 wherein receiving the assessment of the first individual includes receiving the assessment from a user after the user interacts with the first individual, and wherein the assessment of the first individual includes at least one selected from the group including a rating of a willingness of the first individual in providing assistance, a rating of a helpfulness of the first individual, and a rating of a perceived expertise level of the first individual.

7. Logic encoded in one or more tangible media for execution and when executed operable to:
receive a request to locate a source of expertise in a subject area from an initiator of the request, the source of expertise being associated with an enterprise;
determine if there is at least one individual who has the expertise in the subject area, the at least one individual being associated with the enterprise;
identify the at least one individual who has the expertise in the subject area if it is determined that there is the at least one individual who has the expertise in the subject area, wherein the logic operable to identify the at least one individual is further operable to compare a first profile associated with an initiator of the request with a second profile associated with the at least one individual who has the expertise in the subject area; and
provide information associated with the at least one individual who has the expertise in the subject area to the initiator, wherein providing the information associated with the at least one individual who has the expertise in the subject area allows the at least one individual to be identified as the source of expertise in the subject area.

8. The logic of claim 7 wherein the first profile includes profile information associated with search queries of the initiator of the request and profile information associated with document access of the initiator of the request, and wherein the second profile includes profile information associated with search queries of the at least one individual of the request and profile information associated with document access of the at least one individual.

9. The logic of claim 7 wherein if the at least one individual who has the expertise in the subject area includes a first individual and a second individual, the logic operable provide the information associated with the first individual and the second individual is further operable to:
determine if the first individual has a higher expertise ranking than the second individual, the first individual having a first expertise rating and the second individual having a second expertise rating; and
rank the first individual ahead of the second individual in a list if the first expertise rating is higher than the second expertise rating.

10. The logic of claim 9 further operable to:
determine the first expertise rating, wherein the logic operable to determine the first expertise rating is further operable to execute a weighting/scoring algorithm that accounts for at least one selected from the group including a self-rating by the first individual, at least one peer rating that assesses a expertise of the first individual, at least one peer rating that assesses a willingness of the first individual in providing assistance, at least one peer rating that assesses a helpfulness of the first individual, historical search query information associated with the first individual, and historical document access information associated with the first individual.

11. The logic of claim 9 further operable to:
receive an assessment of the first individual; and
update the first expertise rating based on the assessment.

12. The logic of claim 11 wherein the logic operable to receive the assessment of the first individual is further operable to receive the assessment from a user after the user interacts with the first individual, and wherein the assessment of the first individual includes at least one selected from the group including a rating of a willingness of the first individual in providing assistance, a rating of a helpfulness of the first individual, and a rating of a perceived expertise level of the first individual.

13. An apparatus comprising:
means for receiving a request to locate a source of expertise in a subject area from an initiator of the request, the source of expertise being associated with an enterprise;
means for determining if there is at least one individual who has the expertise in the subject area, the at least one individual being associated with the enterprise;
means for identifying the at least one individual who has the expertise in the subject area if it is determined that there is the at least one individual who has the expertise in the subject area, wherein the means for identifying the at least one individual includes means for comparing a first profile associated with an initiator of the request with a second profile associated with the at least one individual who has the expertise in the subject area; and
means for providing information associated with the at least one individual who has the expertise in the subject area to the initiator, wherein providing the information associated with the at least one individual who has the expertise in the subject area allows the at least one individual to be identified as the source of expertise in the subject area.

14. An apparatus comprising:
a searchable data structure, the searchable data structure being arranged to store information associated with a plurality of individuals, wherein the information includes a document access history associated with each individual of the plurality of individuals and a search query history associated with each individual of the plurality of individuals; and
an engine, the engine being arranged to receive a request from a requester that specifies a tag and to use the tag to index into the searchable data structure to identify at least a first individual of the plurality of individuals which is associated with the tag, wherein the engine is further arranged to compare the document access history associated with the first individual and a search query history associated with the first individual to a document access history associated with the requester and a search query history associated with the requester to determine a correlation that is used to calculate an expert rating value for the first individual.

15. The apparatus of claim 14 wherein the engine is further arranged to obtain at least one factor selected from a group including a self-rating by the first individual and a peer assessment of the first individual to determine the expert rating value for the first individual.

16. The apparatus of claim 15 wherein the engine includes weighting/scoring logic, the weighting/scoring logic configured to weigh the at least one factor and the correlation in determining the expert rating value.

17. The apparatus of claim 14 wherein the engine is configured to generate a list of the plurality of individuals associated with the tag.

18. The apparatus of claim 17 wherein the engine is further arranged to calculate expert rating values for each individual of the plurality of individuals and to order the list based on the expert rating values for each individual.

19. The apparatus of claim 18 wherein the expert rating values for each individual are calculated by comparing the document access history associated with each individual and the search query history associated with each individual to the document access history associated with the requester and the search query history associated with the requestor.

20. The apparatus of claim 14 wherein the engine is arranged to allow the requester to select the first individual as a selected expert and to contact the first individual.
